(19) United States
(12) Patent Application Publication
(10) Pub. No.: US 2010/0119761 A1
(43) Pub. Date: May 13, 2010

(54) OPTICAL 3D MEMORY COMPRISING A BLOCK COPOLYMER CONTAINING A PHOTOACTIVE MONOMER HAVING A PHOTOISOMERABLE GROUP

(75) Inventors: Christophe Le Crom, Jurancon (FR); Gilles Meunier, Mazerolles (FR); Michel Glotin, Saint Cloud (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Arkema France, Colombes (FR)

(21) Appl. No.: 12/514,781

(22) PCT Filed: Nov. 26, 2007
(86) PCT No.: PCT/FR07/52398

§ 371 Date: Nov. 18, 2009

(30) Foreign Application Priority Data
Nov. 28, 2006 (FR) 06.55154

(51) Int. Cl. B32B 3/02; C08L 53/00; C08F 226/02; B32B 5/00

(52) U.S. Cl. 428/64.4; 525/88; 526/312; 428/98

(57) ABSTRACT

The present invention relates to a block copolymer comprising: at least a bloc A having a T_{g}>−60° C., preferably a T_{g}>0° C., and most preferably >60°B comprising at least one photoactive monomer having a photoisomerable chromophore. The photoactive monomer having the formula (I), wherein X is H or CH₃—; G is —O—C(═O)—, —C(═O)—O—, a phenyl group, substituted or un-substituted, or —NR—C(═O)—, NR being linked to L and R is H or a C_{1-C}₁₀ alkyl group; L is a spacer group; CR is a photoisomerable chromophore. The block copolymer provides a 3D optical memory. The invention also relates to this optical 3D memory.

### FIELD OF THE INVENTION

The considerable development of digital information systems has led to a growing need to provide data storage units of large capacity, that are compact and that ensure the preservation of data over a long period which may exceed 50 years. Optical storage is one of the technologies that is available for storing data (see, in connection with this, SPIE “Conference on nano- and micro-optics for information systems” Aug. 4, 2003, paper 5225-16).

The technology that is envisaged in the present invention is more particularly that of 3-dimensional (3D) optical storage, as is disclosed in the international Applications WO 01/73 779 and WO 03/070 689 and also in the Japanese Journal of Applied Physics, Vol. 45, N°28, 2006, pp. 1229-1234. It relies on the use of a photoisomerizable chromophore that is in two thermodynamically stable isomeric forms that are interconvertible under the effect of a light radiation of suitable wavelength. When no data has yet been recorded, one of the two forms is predominant. For writing data, the conversion of this isomeric form to the other one is brought about by light radiation having a suitable wavelength. The conversion may be the result of a direct or indirect optical interaction (for example a multiphoton interaction).

The present invention relates to a polymer that makes it possible to carry out 3D optical data storage. It also relates to the material obtained from this polymer and also to the 3D optical memory, especially in disk form.

In Application WO 03/070 689, the chromophores are attached to a polymer by the (co)polymerization of monomers containing said chromophores. Application WO 2006/075 327 points out, in addition, the interest in increasing the chromophore concentration so as to improve the recording sensitivity of the optical memory device. However, when the concentration of the chromophore-containing monomers increases, the mechanical properties of the polymer are affected and the material obtained is either too fragile or too soft to be able to be easily handled. The need exists therefore to develop a rigid material that can be used in the field of 3D optical storage having good data writing and reading abilities.

The Applicant has observed that the block copolymers as defined in claim 1 or the blend as defined in claim 29 solve the posed problem.

### BACKGROUND

U.S. Pat. No. 5,023,859 discloses an optical memory device based on the use of a polymer containing a photosensitive group of stilbene, spiropyran, azobenzene, bisazobenzene, trisazobenzene or azoxybenzene type. The polymer may be a block polymer but there is nothing further specified about the exact nature of this block polymer.

International Application WO 01/73 779 discloses an optical storage unit in which the information is stored due to the cis-trans transition of a molecule (chromophore) having a C═C double bond. The molecule may especially be a diarylalkylene of formula Ar₁R₁C═CR₂Ar₂ which may be bonded to a polymer.

International Application WO 03/070 689 discloses a polymer containing a diarylalkylene type chromophore. The polymer may be a poly(alkyl acrylate) or a poly(alkyl acrylate) copolymer, especially a copolymer with styrene. It may also be polymethyl methacrylate. It is not specified whether it could be a block copolymer or whether the chromophore is present in one of the blocks in particular.

International Application WO 2006/075 328 discloses diarylalkylene type compounds that may be able to be used in optical storage.

International Application WO 2006/075 327 discloses polymers having diarylalkylene type chromophores. Mention is made of a cooperative effect when the chromophore concentration increases.

International Application WO 2006/075 329 discloses a 3D memory device in the form of a disc.

### SUMMARY OF THE INVENTION

The invention relates to a block copolymer comprising:
at least one block A having a T_{g}>−60° C., preferably a T_{g}>0° C., and advantageously >60° C.; and
at least one block B comprising at least one photoactive monomer containing a photoisomerizable chromophore.

The photoactive monomer has the formula (I):

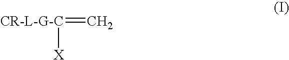

in which:
X denotes H or CH₃—;
G denotes —O—C(═O)—, —C(═O)—O—, a substituted or unsubstituted phenyl group, or else —NR—C(═O)—, NR being linked to L and R being H or a linear or branched C₁-C₁₀ alkyl group;
L denotes a spacer group; and
CR denotes a photoisomerizable chromophore.

The block copolymer makes it possible to obtain a 3D optical memory device. The invention also relates to the blend comprising the block copolymer and a polymer which is a thermoplastic, a thermoplastic elastomer or a thermosetting polymer and also to a 3D optical memory device comprising the block copolymer.

### DETAILED DESCRIPTION OF PREFERRED EMBODIMENTS

T_{g} denotes the glass transition temperature of a polymer measured by DSC according to ASTM E1356. The T_{g} of a monomer is also mentioned, which denotes the T_{g} of the homopolymer having a number-average molecular weight Mₙ of at least 10 000 g/mol, obtained by radical polymerization of said monomer. Thus, it can be said that ethyl acrylate has a T_{g} of −24° C. since the poly(ethyl acrylate) homopolymer has a T_{g} of −24° C. All the percentages are given by weight, except where otherwise mentioned.

The term “photoactive monomer”, is understood to mean a monomer containing a photoisomerizable chromophore group CR. The chromophore exists in two isomeric forms, for example, cis-trans. The conversion from one form to the other is carried out under the action of a light radiation of suitable wavelength.

According to the invention, the photoactive monomer has the formula (I):

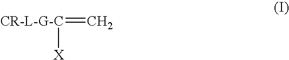

in which:
X denotes H or CH₃—;
G denotes —O—C(═O)—, —C(═O)—O—, a substituted or unsubstituted phenyl group, or else —NR—C(═O)—, NR being linked to L and R being H or a linear or branched C₁-C₁₀ alkyl group;
L denotes a spacer group; and
CR denotes a photoisomerizable chromophore.

The spacer group L has the role of improving the freedom of movement of the chromophore in relation to the copolymer chain so as to promote the conversion of the chromophore from one form to another. This improves the reading capacity and speed. Preferably, L is chosen so that G and CR are linked together by a chain of 2 atoms or more that are linked together by covalent bonds. L may be chosen, for example, from the (CR₁R₂)ₘ, O(CR₁R₂)ₘ and (OCR₁R₂)ₘ groups in which m is an integer higher than 2, preferably between 2 and 10 and R₁ and R₂ independently denote H, halogen or linear or branched alkyl or aryl groups. Preferably, R₁ and R₂ denote H.

The chromophore CR is preferably of the diarylalkylene type existing in the cis and trans isomers. It may be one of the chromophores disclosed in the Applications WO 01/73 779, WO 03/070 689, WO 2006/075 329 or WO 2006/075 327. Preferably, the chromophore CR is chosen so that the energy barrier to the isomerization is above 80 kJ/mol. In fact, it is desirable that the isomerization be a very slow process at room temperature to prevent a loss of recorded data.

Preferably, the photoactive monomer has the formula (II):

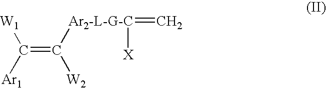

in which:
Ar₁ and Ar₂ denote aryl groups that are possibly substituted; and
W₁ and W₂ are chosen from the groups —CN, —COON, —COOR′, —OH, —SO₂R′ and —NO₂, R′ being a C₁-C₁₀ alkyl or aryl group.

The chromophore corresponds to the group Ar₁W₁C═CW₂Ar₂. L is linked by covalent bonds to Ar₂ and also to G. Ar₁ and Ar₂ denote substituted or unsubstituted aryl groups. They are chosen, for example, independently of one another, from phenyl, anthracene or phenanthrene groups. The possible substituent(s) are chosen from: H, alkyl, NO₂, C₁-C₁₀ alkoxy or halogen, NR″R′″ with R″ and R′″ being H or a linear or branched C₁-C₁₀ alkyl. Ar₁ is attached to the C═C double bond of the chromophore. Ar₂ is attached to the C═C double bond of the chromophore and also to the group L.

Preferably, G is —O—C(═O)— or the C₆H₄ phenyl group, that is to say that the monomer has the formula:

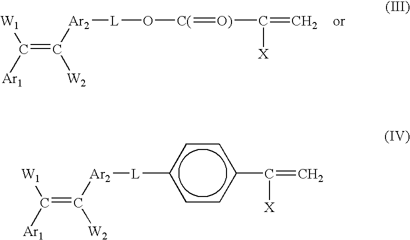

Preferably, Ar₁ is a phenyl group and Ar₂ is a phenyl or biphenyl group, each of the phenyl and/or biphenyl groups may possibly be substituted, that is to say that the chromophore has the formula (V) or (VI):

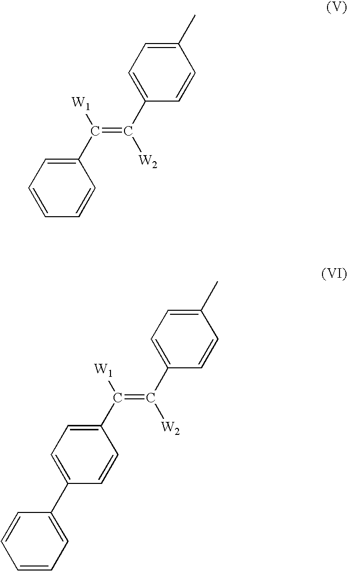

The possible substituents may be, for example, H, aryl, linear or branched C₁-C₁₀ alkyl, NO₂, C₁-C₁₀ alkoxy or halogen.

According to a preferred form, W₁ and W₂ denote CN, Ar₂ is a phenyl group, Ar₁ is a phenyl group substituted in the para position by R₅O—. R₅ denotes a substituted or unsubstituted linear or branched alkyl or aryl group. Preferably, R₅ is a linear or branched C₁-C₄ alkyl group. R₅ may be, for example, a methyl, ethyl, propyl or butyl group. For example, it could be a chromophore of formula (VII):

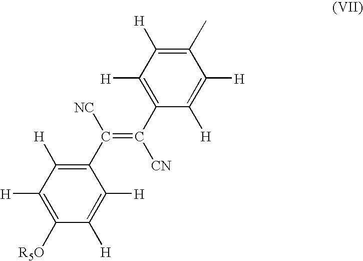

According to another preferred form, W₁ and W₂ denote CN, Ar₂ is a phenyl group, Ar₁ is a biphenyl group substituted in the para position by R₅O—. For example, it could be a chromophore of formula (VIII):

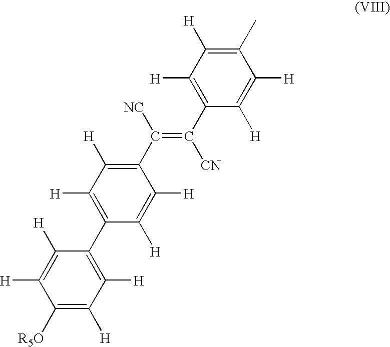

The two monomers below marked eAA and eMMA are more particularly preferred:

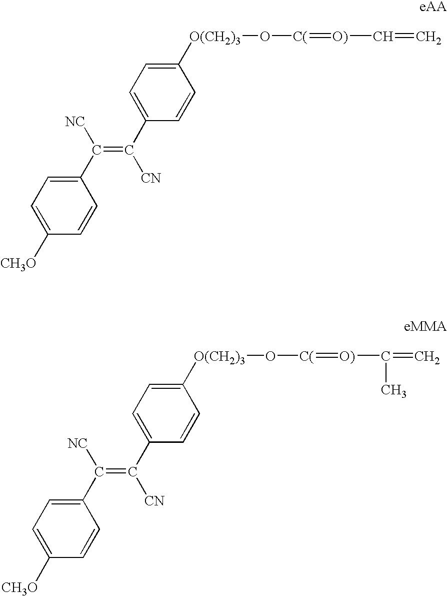

In fact, they have good optical characteristics for writing and reading (see, in connection with this, Japan Journal of Applied Physics Vol. 45, N°28, 2006, pp. 1229-1234):
the trans isomer has a greater fluorescence than the cis;
the trans isomer has a large effective two-photon absorption cross section;
the Stokes shift is greater than 100 nm (little overlap between the absorption spectrum and the emission spectrum with peaks respectively at 375 and 485 nm).

Furthermore, they can be easily copolymerized with a wide range of monomers, in particular by the controlled radical polymerization technique. Finally, they have good stability as the energy barrier to the isomerization is above 80 kJ/mol.

The chromophores that have a small overlap, i.e. <35%, or better still <20%, between the absorption and emission spectra are preferred (see in this regard page 22 of WO 2006/075 327). This makes it possible to increase the chromophore concentration and therefore to promote the cooperative effect without spoiling the signal quality during reading. The overlap depends both on the Stokes shift and on the width of the peak. The overlap is defined as being the percentage of emission which is absorbed per 0.01 M chromophore solution in a 1 cm optical path length cuvette. Preferably, the Stokes shift is >100 nm.

The invention is not limited to particular diarylalkylene type chromophores, but may also be applied to other photoisomerizable chromophores, consisting of, for example, stilbene, spiropyran, azobenzene, bisazobenzene, trisazobenzere or azoxybenzene groups. A list of these chromophores will be found in the following documents U.S. Pat. No. 5,023,859, U.S. Pat. No. 6,875,833 and U.S. Pat. No. 6,641,889.

The term “monomer having a cooperative effect” is understood to mean, a compound of formula (VIII):

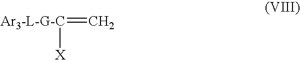

in which:
X, G and L have the same meanings as for the photoactive monomer; and
Ar₃ denotes an aromatic group substituted by at least one substituent having an inductive effect (—I).

This monomer interacts via a cooperative effect with the chromophore and/or improves the cooperative effect between the chromophores themselves, which improves the writing rate. One interpretation of the cooperative effect is that the monomer modifies the microenvironment of the chromophore and promotes the photoisomerization.

The substituent having an inductive effect (—I) is chosen from:
(i) halogens;
(ii) —COOY, —CONYY′, —OY, —SY or —C(═O)Y, Y and Y′ denoting a H or linear or branched C₁-C₁₀ alkyl group.

Advantageously, Ar₃ is a phenyl group. Advantageously, the halogen group is chlorine. Still more advantageously, Ar₃ is chosen from the following groups:

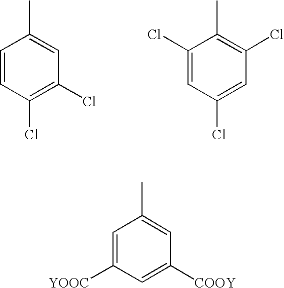

By way of example, the following hindered monomers could be used:

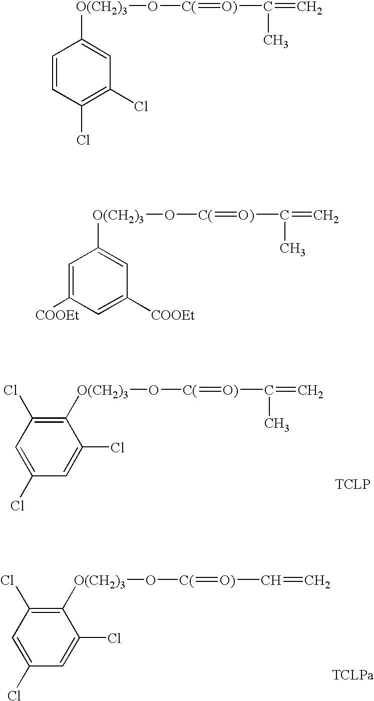

TCLP and TCLPa respectively denote 2,4,6-trichlorophenoxypropyl methacrylate and 2,4,6-trichlorophenoxypropyl acrylate.

Regarding the block A, this can be rigid or soft. It has a T_{g}>−60° C., preferably a T_{g}>0° C., advantageously >60° C., for example >80° C. Preferably, it also has a number-average molecular weight Mₙ>2000 g/mol, advantageously >5000 g/mol, preferably >10 000 g/mol, and for example >50 000 g/mol. The modulus of elasticity of the block (measured by DMA) is preferably >100 MPa, advantageously >500 MPa, preferably >1000 MPa. One of the functions of the block A is to obtain a sufficient mechanical strength of the block copolymer.

The block A is obtained from the polymerization of at least one vinyl, vinylidene, diene, olefin, allyl or (meth)acrylic monomer. This monomer is chosen more particularly from vinylaromatic monomers such as styrene or substituted styrenes, especially alpha-methylstyrene, acrylic monomers such as acrylic acid or its salts, alkyl, cycloalkyl or aryl acrylates such as methyl acrylate, ethyl acrylate, butyl acrylate, ethylhexyl acrylate or phenyl acrylate, hydroxyalkyl acrylates such as 2-hydroxyethyl acrylate, etheralkyl acrylates such as 2-methoxyethyl acrylate, alkoxy- or aryloxy-poly(alkylene glycol) acrylates such as methoxypoly(ethylene glycol)acrylates, ethoxypoly(ethylene glycol)acrylates, methoxypoly(propylene glycol)acrylates, methoxypoly(ethylene glycol)-poly(propylene glycol)acrylates or their mixtures, aminoalkyl acrylates such as 2-(dimethylamino)ethyl acrylate (DMAEA), fluoro acrylates, silyl acrylates, phosphorus acrylates such as alkylene glycol phosphate acrylates, methacrylic monomers such as methacrylic acid or its salts, alkyl, cycloalkyl, alkenyl or aryl methacrylates, such as methyl methacrylate (MMA), lauryl methacrylate, cyclohexyl methacrylate, allyl methacrylate, phenyl methacrylate or naphthyl methacrylate, hydroxyalkyl methacrylates such as 2-hydroxyethyl methacrylate or 2-hydroxypropyl methacrylate, etheralkyl methacrylates such as 2-ethoxyethyl methacrylate, alkoxy- or aryloxy-poly(alkylene glycol) methacrylates such as methoxypoly(ethylene glycol)methacrylates, ethoxypoly(ethylene glycol)methacrylates, methoxypoly(propylene glycol)methacrylates, methoxypoly(ethylene glycol)-poly(propylene glycol)methacrylates or their mixtures, aminoalkyl methacrylates such as 2-(dimethylamino)ethyl methacrylate (DMAEMA), fluoro methacrylates such as 2,2,2-trifluoroethyl methacrylate, silyl methacrylates such as 3-methacryloylpropyltrimethylsilane, phosphorus methacrylates such as alkylene glycol phosphate methacrylates, hydroxyethylimidazolidone methacrylate, hydroxyethylimidazolidinone methacrylate, 2-(2-oxo-1-imidazolidinyl)ethyl methacrylate, acrylonitrile, acrylamide or substituted acrylamides, 4-acryloylmorpholine, N-methylolacrylamide, methacrylamide or substituted methacrylamides, N-methylolmethacrylamide, methacrylamidopropyltrimethyl ammonium chloride (MAPTAC), itaconic acid, maleic acid or its salts, maleic anhydride, alkyl or alkoxy- or aryloxy-poly (alkylene glycol) maleates or hemimaleates, vinylpyridine, vinylpyrrolidinone, (alkoxy) poly(alkylene glycol)vinyl ether or divinyl ether, such as methoxy poly(ethylene glycol)vinyl ether, poly(ethylene glycol)divinyl ether, olefin monomers, among which mention may be made of ethylene, butene, hexene and 1-octene and also fluoro olefin monomers, and vinylidene monomers, among which mention may be made of vinylidene fluoride, these monomers being used alone or as a mixture of at least two aforesaid monomers.

The block A is obtained preferably from styrene and/or from (meth)acrylic monomer(s) and/or from butyl acrylate. Advantageously, the block A comprises styrene and/or MMA and/or butyl acrylate as the main monomer(s). Preferably, it comprises from 80 to 100% of styrene and/or MMA and/or butyl acrylate.

The block A is intended to confer the mechanical properties of strength and/or of rigidity of the finished material.

According to the method of preparing the block copolymer, one or more monomer(s) making up the block(s) B, especially photoactive monomer or monomer having a cooperative effect, that are not completely polymerized, may remain when the polymerization leading to block(s) A is initiated. The block(s) A may therefore comprise the monomer(s) initially introduced to prepare the block(s) B. Thus, the block A may comprise from 80 to 100 wt % of styrene and/or MMA, from 0 to 10 wt % of at least one cornonomer chosen from the previously defined list and from 1 to 10 wt % of at least one photoactive monomer, the total making 100 wt %. The comonomer must be able to be copolymerized with styrene and/or MMA and also with the photoactive monomer.

Regarding the block B, this comprises at least one photoactive monomer and possibly at least one other monomer that can be copolymerized with the photoactive monomer. The other monomer may be chosen from the previously defined list of monomers. It may also be a monomer having a cooperative effect. The content of photoactive monomer in block B may range from 5 to 100 wt %.

According to a preferred form, the monomer that is copolymerized with the photoactive monomer is a monomer having a cooperative effect. It is preferably TCLP or TCLPa. The block B therefore comprises 10 to 80 wt % of at least one photoactive monomer, 10 to 80 wt % of at least one monomer having a cooperative effect and possibly a third monomer selected from the previous list (the total making 100 wt %). A monomer having a T_{g}<0° C., advantageously <−20° C., better still <−40° C., such as, for example, butyl acrylate (examples 3 or 4 illustrate this preferred form) or alternatively >0° C. such as methyl methacrylate may be used as third monomer.

Regarding the block copolymer of the invention, this comprises at least one block A and at least one block B comprising at least one photoactive monomer.

According to the definition given in 1996 by IUPAC in its recommendations on polymer nomenclature, a block copolymer consists of adjacent blocks that are constitutionally different, that is to say, blocks comprising units derived from different monomers or from a same monomer, but having a different composition or sequential distribution of the units. A block copolymer may be, for example, a diblock, triblock or star copolymer.

Preferably, the block copolymer is such that the block(s) A and the block(s) B are incompatible, that is to say that they have a Flory-Huggins interaction parameter of χ_{AB} >0 at room temperature. This causes a phase microseparation with formation of a diphasic structure at macroscopic level. The linear copolymer is then nanostructured, that is to say that it forms areas where the size is less than 100 nm, preferably between 10 and 50 nm. The nanostructuration has the advantage of leading to a transparent material. Furthermore, it makes it possible to obtain concentrated chromophore areas since there is no dilution by the block(s) A, which makes it possible to promote the cooperative effect between chromophores (with an increase in the writing rate).

The block copolymer is preferably an A-B-A′ triblock copolymer comprising a central block B linked by covalent bonds to two side blocks A and A′ (that is to say positioned on each side of the central block B). A and A′ may be identical or different (this type of copolymer is sometimes also known as A-b-B-b-A′). It may also be a B-A-B′ triblock copolymer comprising a central block A linked by covalent bonds to two side blocks B and B′ (that is to say positioned on each side of the central block A) that comprise chromophore units. B and B′ may be identical or different.

Among the ABA′ or BAB′ triblock copolymers, mention will be made, more particularly, of those for which:
the blocks A and A′ comprise styrene and/or MMA and/or butyl acrylate as the main monomer(s);
the blocks B and B′ comprise 10 to 60 wt % of at least one photoactive monomer, 10 to 60 wt % of at least one monomer having a cooperative effect and possibly one monomer from the previous list (the total making 100 wt %), which is preferably an alkyl (meth)acrylate, more particularly methyl methacrylate.

The block copolymer may be used alone or else in a blend with another polymer that has sufficient transparency in the wavelength region used for writing or reading and also a low birefringence. It may be a thermoplastic, a thermoplastic elastomer or a thermoset. This characteristic is important for 3D optical memory technology for which it is necessary that the light ray reaches each of the memory layers without being disturbed. Preferably a thermoplastic such as a homo- or copolymer of methyl methacrylate or of styrene, or else a polycarbonate, is used. The blend comprises 50 to 100 wt %, advantageously 75 to 100 wt %, preferably 90 to 100 wt %, of block copolymer respectively per 0 to 50 wt %, advantageously 0 to 25 wt %, preferably 5 to 10 wt % of the thermoplastic. The blend is produced using any of the techniques for blending thermoplastics that are known to those skilled in the art. Preferably extrusion is used. The block copolymer and/or the blend may possibly also comprise various additives (antistatic, lubricant, dye, plasticizer, antioxidant, UV stabilizer, etc.).

Method of Producing the Block Copolymer

The block copolymer is produced using polymerization techniques known to those skilled in the art. One of these polymerization techniques may be anionic polymerization such as is, for example, taught in the following documents FR 2 762 604, FR 2 761 997 and FR 2 761 995. The controlled radical polymerization technique may also be used, which comprises several variants depending on the nature of the control agent that is used. Mention may be made of SFRP (Stable Free Radical Polymerization) that uses nitroxides as the control agent and may be initiated by alkoxyamines, ATRP (Atom Transfer Radical Polymerization) that uses metal complexes as the control agent and is initiated by halogen agents, RAFT (Reversible Addition Fragmentation Transfer) that requires, for its part, sulphur products such as dithioosters, trithiocarbonates, xanthates or dithiocarbamate. It is possible to refer to the general review of Matyjaszewski, K. (Ed.), ACS Symposium Series (2003), 854 (Advances in Controlled/Living Radical Polymerization) and also to the following documents for more details on the controlled radical polymerization techniques which may be used: FR 2 825 365, FR 2 863 618, FR 2 802 208, FR 2 812 293, FR 2 752 238, FR 2 752 845, U.S. Pat. No. 5,763,548 and U.S. Pat. No. 5,789,487.

The controlled radical polymerization with nitroxide T control is the preferred technique for producing the block copolymer of the invention. In fact, this technique does not necessitate working under conditions as strict as in anionic polymerization (that is to say, in the absence of moisture and at a temperature <100° C.). It also makes it possible to polymerize a wide range of monomers. It may be carried out under various conditions, for example in bulk, in solvent or in a dispersed medium such as aqueous suspension or emulsion.

The nitroxide T is a stable free radical having a ═N—O. group, that is to say a group on which an unpaired electron is present. A stable free radical denotes a radical that is very long-lasting and non-reactive with respect to air and to moisture in the ambient air, which may be controlled and kept for a much longer time than the majority of free radicals (see, in connection with this, Accounts of Chemical Research 1976, 9, 13-19). The stable free radical is thus distinguished from the free radicals whose lifetime is short-lived (a few milliseconds to a few seconds) as the free radicals derived from the common polymerization initiators such as peroxides, hydroperoxides or azo initiators. The free radical polymerization initiators tend to accelerate the polymerization while the stable free radicals generally tend to slow it down. It may be said that a free radical is stable in the sense of the present invention if it is not a polymerization initiator and if, under the normal conditions of the invention, the average lifetime of the radical is at least one minute.

The nitroxide T is represented by the structure (IX):

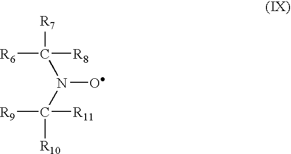

in which R₆, R₇, R₈, R₉, R₁₀ and R₁₁ denote C₁-C₂₀, preferably C₁-C₁₀, linear or branched alkyl groups, such as substituted or unsubstituted methyl, ethyl, propyl, butyl, isopropyl, isobutyl, tert-butyl and neopentyl groups, substituted or unsubstituted C₆-C₃₀ aryl groups such as benzyl and aryl(phenyl) groups and C₁-C₃₀ saturated cyclics and in which the groups R₆ and R₉ may make part of a, possibly substituted, cyclic structure R₆—CNC—R_{g} which may be chosen from:

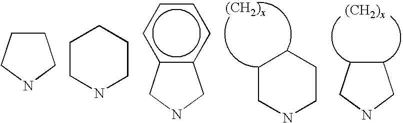

x denoting an integer between 1 and 12.

By way of example, the following nitroxides could be used:

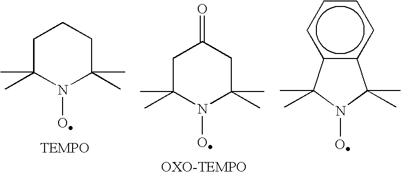

In a particularly preferred manner, the nitroxides of formula (X) are used within the scope of the invention:

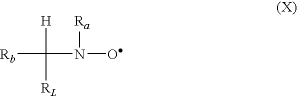

Rₐ and R_{b} denoting identical or different alkyl groups having 1 to 40 carbon atoms, possibly linked together so as to form a ring and possibly substituted by hydroxy, alkoxy or amino groups;
R_{L} denoting a monovalent group with a molar mass greater than 16 g/mol, preferably greater than 30 g/mol. The group R_{L} may for example have a molar mass between 40 and 450 g/mol. It is preferably a phosphorus group of general formula (XI):

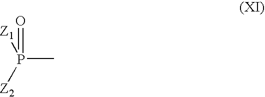

in which Z₁ and Z₂, which may be identical or different, may be chosen from alkyl, cycloalkyl, alkoxyl, aryloxyl, aryl, aralkyloxyl, perfluoroalkyl and aralkyl radicals, and may comprise 1 to 20 carbon atoms (the alkyl group or moiety being linear or branched); Z₁ and/or Z₂ may also be a halogen atom such as a chlorine, bromine or fluorine atom.

Advantageously, R_{L} is a phosphonate group of formula:

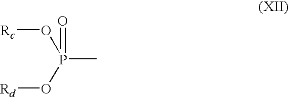

in which R_{c} and R_{d} are two identical or different alkyl groups, possibly linked so as to form a ring, comprising 1 to 40 carbon atoms and possibly substituted or unsubstituted.

The group R_{L} may also comprise at least one aromatic ring such as the phenyl radical or the naphthyl radical, substituted for example by one or more linear or branched alkyl radical(s) comprising 1 to 10 carbon atoms.

The nitroxides of formula (X) are preferred since they make it possible to obtain good control over the radical polymerization of (meth)acrylic monomers. The alkoxyamines of formula (XIII) are preferred:

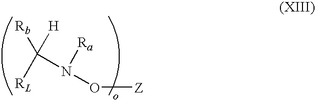

in which Z denotes a multivalent group and o denotes an integer between 1 and 10. Z is a group capable of liberating several radical sites after thermal activation and rupture of the Z-T covalent bond. Examples of Z groups can be found on pages 15 to 18 of international Application WO 2006/061,523. Preferably, Z is a divalent group, that is to say that the integer o equals 2.

To produce a triblock copolymer using the controlled radical polymerization technique, advantageously a bifunctional alkoxyamine of formula T-Z-T (that is to say, an alkoxyamine of formula (XIII) with o=2) may be used. To start with the central block is prepared by polymerizing, using the alkoxyamine, the blend of monomers leading to the central block. The polymerization takes place with or without solvent, or else in a dispersed medium. The blend is heated to a temperature above the activation temperature of the alkoxyamine. When the central block is obtained, the monomer(s) leading to the side blocks are added. It could be that at the end of the preparation of the central block, some monomers remain that have not been completely consumed that may or may not be chosen to be eliminated before the preparation of the side blocks. The elimination may consist, for example, in precipitating in a nonsolvent, recovering and drying the central block. If it is chosen not to eliminate the monomers that have not been completely consumed, they may polymerize with the monomers introduced to prepare the side blocks.

Writing/Reading of Data

The optical principles which underlie the present invention are the same as those described in International Applications WO 01/73,779 and WO 03/070,689 which have already been published. Writing relies on the conversion from one isomeric form to another under the effect of light radiation. The conversion necessitates having a chromophore in an excited state, which necessitates absorption at an energy level E. The absorption of two photons is facilitated by combining the energy of at least two photons of one or more light beam(s) which have energy levels E₁ and E₂ which may be different from E. The two light beams are in the UV, visible, or near infrared region. Preferably, only one light beam is used and the conversion is the result of a two-photon absorption process.

Reading may rely on a linear or non-linear electronic excitation process. The spectra of emission of the two isomers are different and the emission is collected using an appropriate reading device. A non-linear process such as Raman dispersion or a four wave mixing process may be used.

A small volume portion of the 3D memory contains chromophores predominantly in one isomeric form or else in the other. The volume portion contains therefore information stored in a well defined and localized zone of the memory device and is characterized by an optical signal which is different from that of its immediate vicinity.

Regarding 3D Optical Memory

The invention also relates to the 3D optical memory device (or 3D optical storage unit) comprising the block copolymer or the blend of the invention and which is used to record (store) data. A 3D memory device is a memory device that allows data to be stored at any point (defined by three coordinates x, y and z) of the volume on the memory device. A 3D memory device allows the data to be stored in several virtual layers (or virtual levels). The volume of the 3D memory device is therefore linked to the physical volume occupied by the said device.

This memory device is, for example, in the form of a square or rectangular plate, a cube or else a disk which comprises the block copolymer of the invention, possibly in the form of a blend as was described. It is possible to obtain the 3D memory device by injection molding the block copolymer or the blend. This conversion technique is known by plastics processors and consists in injecting, under pressure, the molten material into a mold (in connection with this, reference could be made to ‘Précis de matières plastiques” [Plastics Handbook], Nathan, 4th edition, ISBN 2-12-355352-2, pp. 141-156). The material is melted and compressed using an extruder. It is also possible to superpose several layers comprising the block copolymer or the blend of the invention as taught in International Application WO 2006/075329.

Preferably, the 3D optical memory device is in disk form which allows it to be rotated, the writing or reading head being essentially stationary. The disk may be produced by injection-molding or molding of the block copolymer or of the blend if it has suitable mechanical characteristics. It may also be produced by deposition of the block copolymer or of the blend on a rigid and transparent support in the wavelength region used for writing and/or reading.

### Examples

The BLOCBUILDER® corresponds to the product of formula:

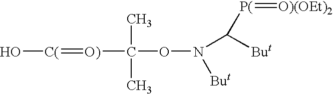

### Example 1

### Preparation of a Bifunctional Dialkoxyamine

Introduced into a 250 cm³ glass reactor inerted with nitrogen, were 125 ml of ethanol, 38 g of BLOCBUILDER® and 10 g of 1,4-butanediol diacrylate. The reaction mixture was brought to 80° C. for 4 h with stirring (250 rpm). The resulting mixture was then cooled and the ethanol evaporated under vacuum. The resulting solid was a dialkoxyamine that was then used as it was.

### Preparation of a Triblock Copolymer poly(MMA/eAA)-b-poly(butyl acrylate/eAA)-b-poly(MMA/eAA)

Step 1: Under an inert atmosphere, 5 g of eAA, 45 g of butyl acrylate and 0.99 g of the preceding alkoxyamine were introduced into a 100 ml reactor stirred at 400 rpm, and the mixture was brought to 115° C. for 5 h 20 min. At the end of this step, the monomer conversion was fixed at 60%. The residual butyl acrylate was evaporated under vacuum. The monomer eAA that had not been consumed did not evaporate under vacuum.

Step 2: The following were introduced into a 100 cm³ reactor stirred at 400 rpm and under an inert atmosphere: 5.75 g of the mixture from Step 1 (that is to say, the polymer and the residual monomer eAA that had not evaporated), 38.3 g of methyl methacrylate and 36 g of toluene, and this mixture was brought to 105° C. for 1 h 30 min, then to 120° C. for 1 h 30 min.

At the end of this step, the methyl methacrylate that had not reacted was evaporated under vacuum, as was the toluene. The product obtained was a poly(MMA/eAA)-b-poly(butyl acrylate/eAA)-b-poly(MMA/eAA)triblock copolymer.

### Example 2

### Preparation of a Polymer Which was a Blend of a PMMA-b-poly(butyl acrylate/eAA)-b-PMMA Triblock Copolymer and a poly(butyl acrylate/eAA)copolymer

Under an inert atmosphere 20 g of eA, 30 g of butyl acrylate and 0.98 g of the preceding bifunctional alkoxyamine were introduced into a 100 ml reactor stirred at 400 rpm and the mixture was brought to 115° C. for 7 h. At the end of this step the monomer conversion was fixed at 60%. A solution of 0.2 g of LUPEROX® 546 and 0.2 g of n-dodecyl mercaptan in 50 g of toluene was added to this resulting reaction mixture. Stirring was maintained for 8 h at 115° C.

Under an inert atmosphere 11.7 g of the preceding solution were put back into a 100 ml reactor stirred at 400 rpm for 1 h 30 min at 105° C. and for 1 h 30 min at 120° C., in the presence of 38.9 g of methyl methacrylate and 39 g of toluene. At the end of this step, the monomer that had not reacted and the toluene were evaporated. The product obtained was a blend of a PMMA-b-poly(butyl acrylate/eAA)-b-PMMA triblock copolymer and a poly(butyl acrylate/eAA) copolymer.

### Example 3

The following BAB copolymer was prepared:

block B: eMMATTCLP/butyl acrylate copolymer

rigid block A: polystyrene

### Preparation of the Block A

Introduced into a 5 litre stainless steel reactor, were 3000 g of styrene and 21.625 g of the preceding bifunctional alkoxyamine. The mixture was heated, with stirring, for 6 hours at 115° C. until a 60% conversion was reached, and the unconsumed styrene was drawn off and evaporated under vacuum.

The PS block had the following characteristics:

number-average molecular weight: Mₙ═63 190 g/mol

weight-average molecular weight: M_{w}=110 210 g/mol

polydispersity index: 1.74

### Preparation of the B Blocks

Introduced into a 500 cm³ glass reactor, 53.74 g of PS block (diluted in ethylbenzene), 8.18 g of eMMA, 8.18 g of TCLP and 1.82 g of butyl acrylate. The mixture was heated at 125° C. for 6 hours, then it was cooled to 120° C. Next, 0.04 g of LUPEROX® 531 (diluted to 10 wt % in ethylbenzene) was introduced and the heating was maintained for 2 h 30 min at 120° C. The mixture was cooled, the product drawn off, and the solvent was evaporated.

The final product was a blend of the BAB block copolymer and a copolymer B. The butyl acrylate makes it possible to correct the refractive index of the TCLP/eMMA system relative to the polystyrene of the PS block in order to prevent the formation of haze.

### Example 4

The following ABA copolymer was prepared:

block B: eMMA/TCLP/butyl acrylate copolymer

rigid block A: polystyrene

The function of butyl acrylate is identical to that of example 3.

### Preparation of Block B

Into a 500 cm³ glass reactor, 18 g of eMMA, 18 g of TCLPa, 4 g of butyl acrylate and 0.577 g of the preceding bifunctional alkoxyamine were introduced. The mixture was heated at 125° C. for 7 hours with stirring, then 25 g of ethylbenzene were added. The mixture was cooled to 85° C. and 0.047 g of AlBN in 25 g of ethylbenzene were added and the heating was maintained for 6 hours.

The block B then had the following characteristics:

number-average molecular weight: Mₙ=16 060 g/mol

weight-average molecular weight: M_{w}=32 020 g/mol

polydispersity index: 2.24

### Preparation of the A Blocks

60 g of styrene were introduced to the preceding mixture, and it was heated at 120° C. for 6 hours. It was cooled, the mixture was drawn off and the solvent and unreacted styrene were evaporated.

The block copolymer had the following characteristics:

number-average molecular weight: Mₙ=28 050 g/mol

weight-average molecular weight: M_{w}=78 600 g/mol.

### Example 5

### Disk Production

The polymer solutions obtained in examples 1 to 4 were precipitated in a large amount of methanol at ambient temperature, filtered, washed and then dried.

The product obtained was then shaped by compression molding at 150° C. for 10 min in order to form a disk having a diameter of 2 cm and a thickness of 2 mm. The light transmission was greater than 90% over the entire visible range.

This disk was then subjected to a static data reading/writing test using an appropriate laser device. Recording of the data on the disk was observed.

1-35. (canceled)

36. A block copolymer comprising:
at least one block A having a T_{g}>−60° C. and
at least one block B comprising at least one photoactive monomer comprising a photoisomerizable chromophore of formula (I): 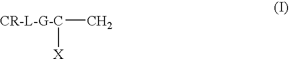
wherein:
X denotes H or CH₃—;
G denotes —O—C(═O)—, —C(═O)—O—, a substituted or unsubstituted phenyl group, or —NR—C(═O)—, wherein NR is linked to L and R is H or a linear or branched C₁-C₁₀ alkyl group;
L denotes a spacer group; and
CR denotes a photoisomerizable chromophore.

37. The block copolymer of claim 36, wherein the at least one block A has a T_{g}>0° C.

38. The block copolymer of claim 37, wherein the at least one block A has a T_{g}>60° C.

39. The block copolymer of claim 36, wherein the spacer group L is chosen so that G and CR are linked together by a chain of two or more atoms that are bonded together by covalent bonds.

40. The block copolymer of claim 36, wherein L comprises (CR₁R₂)ₘ, O(CR₁R₂)ₘ or (OCR₁R₂)ₘ, wherein m is an integer greater than or equal to 2, and R₁ and R₂ independently denote H, halogen, or linear or branched alkyl or aryl groups.

41. The block copolymer of claim 40, wherein m is an integer ranging from 2 to 10.

42. The block copolymer of claim 36, wherein the chromophore CR is of diarylalkylene type.

43. The block copolymer of claim 36, wherein the chromophore CR has an overlap of <35% when spectra are recorded on a 0.01 M chromophore solution in a 1 cm optical path length cuvette.

44. The block copolymer of claim 36, wherein the Stokes shift is >100 nm.

45. The block copolymer of claim 36, wherein the photoactive monomer has the formula (II): 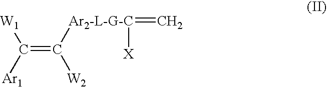
wherein:
Ar₁ and Ar₂ denote aryl groups that are optionally substituted; and
W₁ and W₂ comprise the groups —CN, —COOH, —COOR′, —OH, —SO₂R′ or —NO₂,
wherein R′ is a linear or branched C₁-C₁₀ alkyl or aryl group.

46. The block copolymer of claim 45, wherein Ar₁ and Ar₂ independently comprise phenyl, anthracene or phenanthrene groups.

47. The block copolymer of claim 45, wherein the photoactive monomer has the formula (III) or (IV): 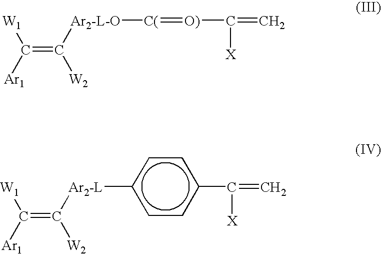
wherein:
Ar₁ and Ar₂ denote aryl groups that are optionally substituted; and
W₁ and W₂ comprise the groups —CN, —COOH, —COOR′, —OH, —SO₂R′ or —NO₂,
wherein R′ is a linear or branched C₁-C₁₀ alkyl or aryl group.

48. The block copolymer of claim 36, wherein the chromophore comprises: 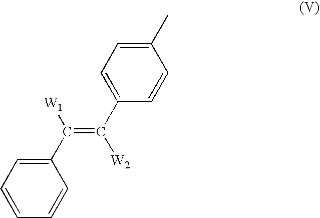
wherein:
W₁ and W₂ comprise the groups —CN, —COOH, —COOR′, —OH, —SO₂R′ or —NO₂,
wherein R′ is a linear or branched C₁-C₁₀ alkyl or aryl group and each of the phenyl rings are optionally substituted.

49. The block copolymer of claim 48, wherein Ar₁ is a phenyl group and Ar₂ is a phenyl or biphenyl group, further wherein each of the phenyl and/or biphenyl groups are optionally substituted.

50. The block copolymer of claim 49, wherein:
W₁ and W₂ denote CN,
Ar₂ is a phenyl group,
Ar₁ is a phenyl or biphenyl group substituted in the para position by R₅O—, and
R₅ denotes a substituted or unsubstituted alkyl or aryl group.

51. The block copolymer of claim 45, wherein the photoactive monomer is eAA or eMMA of formulae:

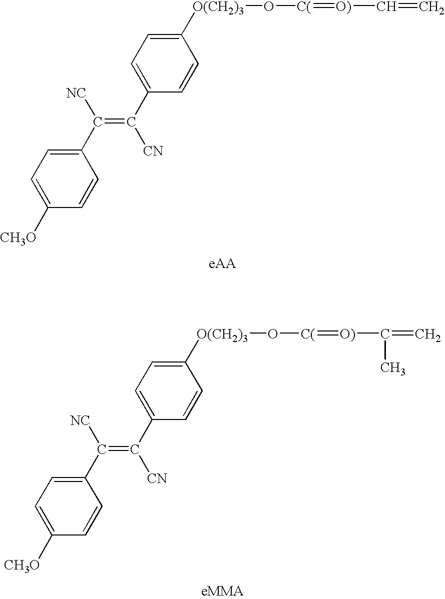

52. The block copolymer of claim 36, wherein the chromophore CR comprises a stilbene, spiropyran, azobenzene, diazobenzene, triazobenzene or azoxybenzene group.

53. The block copolymer of claim 36, wherein the block A has a number-average molecular weight Mₙ>2000 g/mol.

54. The block copolymer of claim 53, wherein the block A has a number-average molecular weight Mₙ>5000 g/mol.

55. The block copolymer of claim 54, wherein the block A has a number-average molecular weight Mₙ>10 000 g/mol.

56. The block copolymer of claim 55, wherein the block A has a number-average molecular weight Mₙ>50 000 g/mol.

57. The block copolymer claim 52, wherein the modulus of elasticity of the block A is >100 MPa.

58. The block copolymer claim 57, wherein the modulus of elasticity of the block A is >500 MPa.

58. The block copolymer claim 57, wherein the modulus of elasticity of the block A is >500 MPa.

59. The block copolymer claim 58, wherein the modulus of elasticity of the block A is >1000 MPa.

60. The block copolymer of claim 36, wherein the block A is obtainable from the polymerization of at least one vinyl, vinylidene, diene, olefin, allyl or (meth)acrylic monomer.

61. The block copolymer of claim 57, wherein the block A comprises styrene and/or MMA as the main monomer(s).

62. The block copolymer of claim 61, wherein the block A comprises from 80 to 100% of styrene and/or MMA.

63. The block copolymer of claim 61, wherein the block A is a rigid block.

64. The block copolymer of claim 36, wherein the block B comprises at least one photoactive monomer and at least one other monomer that can be copolymerized with the photoactive monomer.

65. The block copolymer of claim 64, wherein the monomer that is copolymerized with the photoactive monomer has a T_{g}<0° C.

66. The block copolymer of claim 63, wherein the block B comprises from 5 to 95 wt % of at least one photoactive monomer, and from 95 to 5 wt % of at least one monomer with a T_{g}<0° C.

67. The block copolymer of claims 63, wherein the block B comprises a monomer having a cooperative effect of formula (IX): 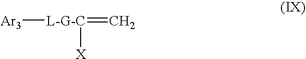
wherein:
L comprises (CR₁R₂)ₘ, O(CR₁R₂)ₘ or (OCR₁R₂)ₘ,
wherein m is an integer greater than or equal to 2, and R₁ and R₂ independently denote H, halogen, or linear or branched alkyl or aryl groups; and
Ar₃ denotes an aromatic group substituted by at least one substituent having an inductive effect (—I).

68. The block copolymer of claim 67, wherein the substituent having an inductive effect (—I) comprises:
(i) a halogen; and
(ii) —COOY, —CONYY′, —OY, —SY or —C(═O)Y,
wherein Y and Y′ denote an H or a linear or branched C₁-C₁₀ alkyl group.

69. The block copolymer of claim 68, wherein said halogen is chlorine.

70. The block copolymer of claim 67, wherein Ar₃ is a phenyl group.

71. The block copolymer of claim 67, wherein the monomer having a cooperative effect comprises:

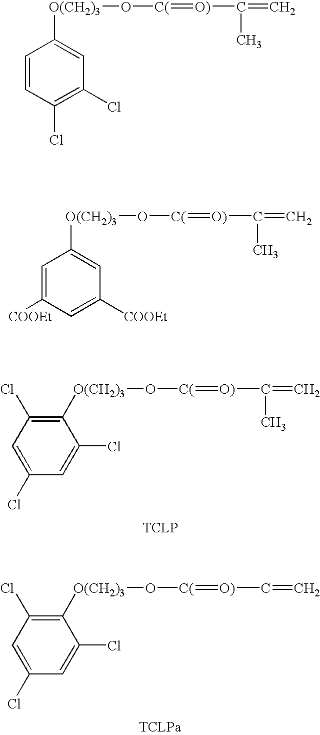

72. The block copolymer of claim 66, wherein the block B comprises from 10 to 80 wt % of at least one photoactive monomer, from 10 to 80 wt % of at least one monomer having a cooperative effect, and optionally a third monomer.

73. A blend comprising the block copolymer of claim 36 and a thermoplastic or thermosetting polymer.

74. The blend of claim 73, wherein said thermoplastic is a thermoplastic elastomer.

75. The blend of claim 73, wherein said blend comprises from 50 to 100 wt % of the block copolymer per 0 to 50 wt % of the thermoplastic or thermosetting polymer.

76. The blend of claim 75, wherein said blend comprises from 75 to 100 wt % of the block copolymer per 0 to 25 wt % of the thermoplastic or thermosetting polymer.

77. The blend of claim 76, wherein said blend comprises from 90 to 100 wt % of the block copolymer per 5 to 10 wt % of the thermoplastic or thermosetting polymer.

78. The blend of claim 73, wherein the thermoplastic polymer is a homo- or copolymer of methyl methacrylate or the thermoplastic polymer is a polycarbonate.

79. A 3D optical memory device comprising the block copolymer of claim 36.

80. A 3D optical memory device comprising the blend of claim 73.

81. The 3D optical memory device of claim 79, wherein said 3D optical memory device is in the form of a square or rectangular plate, a cube, or a disk.

82. A method comprising the step of storing optical data on an optical data storage unit comprising the block copolymer of claim 36.

83. The method of claim 82, wherein said block copolymer is blended with a thermoplastic or thermosetting polymer.

84. The method of claim 83, wherein said thermoplastic is a thermoplastic elastomer.
